(19) United States
(12) Patent Application Publication
(10) Pub. No.: US 2005/0138017 A1
(43) Pub. Date: Jun. 23, 2005

(54) Health care enterprise directory

(76) Inventors: Ronald Keen, Shelburne, VT (US); Erik Preiss, Underhill, VT (US); Debra Stenner, Ferrisburgh, VT (US)

Correspondence Address: FENWICK & WEST LLP, SILICON VALLEY CENTER, 801 CALIFORNIA STREET, MOUNTAIN VIEW, CA, 94041, US

(21) Appl. No.: 10/997,766

(22) Filed: Nov. 23, 2004

Related U.S. Application Data
(60) Provisional application No. 60/525,246, filed on Nov. 26, 2003.

(51) Int. Cl. G06F 7/00

(52) U.S. Cl. 707/3

(57) ABSTRACT

A single enterprise directory integrates data produced by various healthcare information systems and third party medical products. The directory provides access to disparate data object, systems, and applications to allow for workflow management and enhance client service. The directory is equipped to provide notifications of changes or additions made to relevant partient data, and access to one or more data objects.

### CROSS REFERENCE TO RELATED APPLICATIONS

The present application claims the benefit of U.S. Provisional Patent Application Ser. No. 60/525,246 filed Nov. 26, 2003, entitled “Enterprise Data Directory in Support of Diverse Data Types in a Healthcare Information System,” which is hereby incorporated by reference in its entirety.

### BACKGROUND

1. Field of the Invention

The present invention relates generally to healthcare data management and specifically, to data integration and access systems for enterprise settings.

2. Background of the Invention

The delivery of health care services involves multiple information and medical imaging systems. Such systems are often characterized by a lack of integration between various document and imaging devices and the hospitals, laboratories, and clinics in which patient care is administered. In addition, healthcare IT (information technology) products and information systems often use non-standard, proprietary formats that make it difficult to develop a unified approach to image or non-image objects.

Due in part to their heterogeneity, individual healthcare systems are largely ignorant of the full breadth of data objects that relate to a patient, i.e., they only store and process one or more specific types of data supported by the system. This makes it difficult for healthcare providers to access relevant healthcare image or non-image data objects to track workflow, patient care, and billing. Furthermore, healthcare information systems do not communicate acquisition events of healthcare data objects. As a result, healthcare providers are often unaware of and/or unable to access up-to-date patient information. Furthermore, systems are poorly equipped to share images and information that they produce. This creates specialty pockets of information and makes it difficult to generate patient records that encompass all relevant patient information.

### SUMMARY OF THE INVENTION

The present invention overcomes the deficiencies and limitations of the prior art by providing systems and methods by which disparate healthcare systems can access, receive notifications of, and share image and other data objects. Although the methods and systems disclosed herein are particularly useful in the fields of radiology, cardiology, pathology, oncology, among others, in which images and other non-searchable data types are generated, they are generally useable across a wide variety of IT systems.

An enterprise directory indexes data objects captured by or resident in various healthcare systems. It receives updates of these changes in status as well as a reference to or copy of the data object itself by various subscribing systems distributed across a healthcare enterprise. The enterprise directory can classify the data object in the directory according to any of a number of parameters, provided either in the notification, by a user, or generated by the enterprise directory.

The enterprise directory notifies subscribing systems of changes or updates to data objects by broadcasting messages. When a user wants to access a data object, the directory can provide a viewer or other application and deliver it over a network to the user. The directory engine performs various functions associated with providing services to the subscribing systems including processing notifications, generating messages, providing reports, and implementing audit controls. Instructions for carrying out such functions may be provided through one or more user interfaces accessible to a user through a web framework, specialized application, or other communications interface.

### BRIEF DESCRIPTION OF THE INVENTION

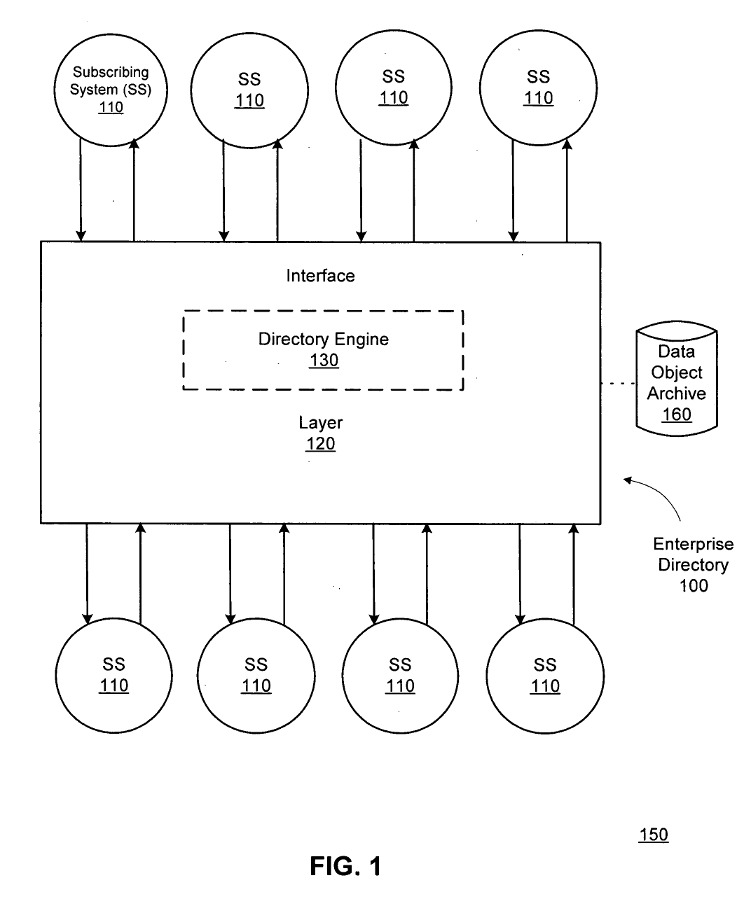

FIG. 1 is high-level block diagram of a health care information setting including an enterprise directory in accordance with an embodiment of the invention.

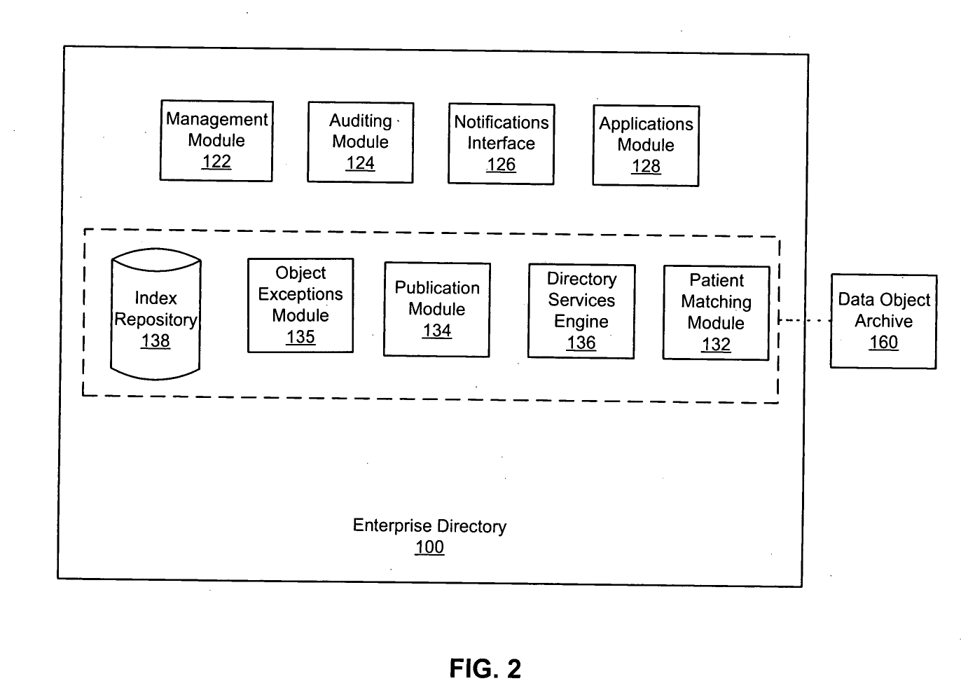

FIG. 2 is a block diagram of the enterprise directory of FIG. 1 in accordance with an embodiment of the invention.

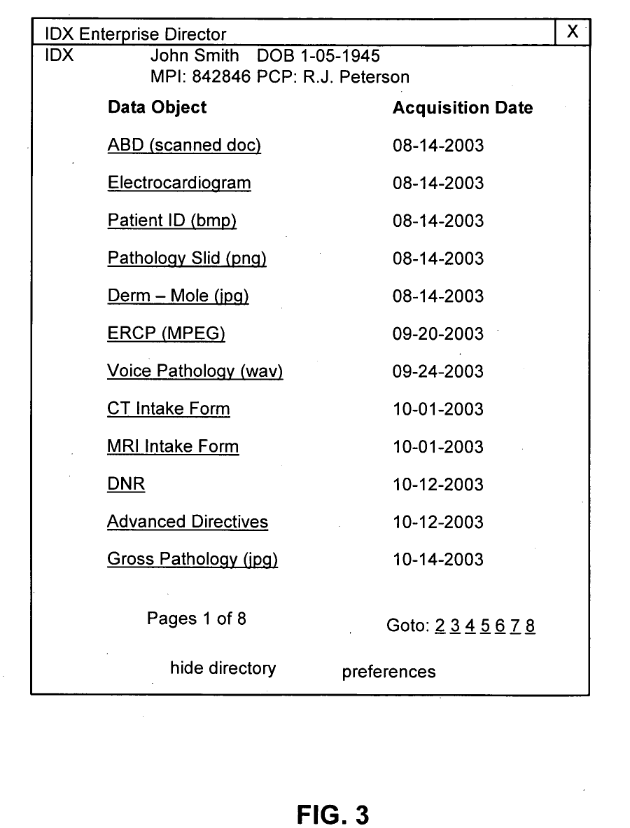

FIG. 3 depicts an exemplary interface for using an enterprise directory in accordance with an embodiment of the invention.

### DETAILED DESCRIPTION OF THE INVENTION

Reference will now be made in detail to several embodiments of the present invention(s), examples of which are illustrated in the accompanying figures. It is noted that wherever practicable, similar or like reference numbers may be used in the figures and may indicate similar or like functionality. The figures depict embodiments of the present invention for purposes of illustration only. One skilled in the art will readily recognize from the following description that alternative embodiments of the structures and methods illustrated herein may be employed without departing from the principles of the invention described herein.

Embodiments of the present invention provide an enterprise directory capable of supporting a diverse array of data objects in a healthcare information system. The term “enterprise directory” is used throughout this specification interchangeably with “enterprise data directory,” “enterprise director,” and “enterprise directory system.” In an embodiment of the invention, an enterprise data directory provides a common integration layer for data management and processing in a healthcare information setting or system that includes multiple disparate medical information systems and heterogeneous data objects of different types (e.g. image and report) and formats (e.g. JPEG and .XML). The terms “data object” and “medical data object” may refer to various types of data or pieces of information, including, for example, medical images, videos, .wav files, non-medical images, and on-line forms, as well as documents in PDF, TIFF, BITMAP, GIF, JPEG, and various other formats, including textual, tabular, graphical, HTML (Hypertext Markup Language), or XML (Extensible Markup Language) formats. Specific data objects may comprise, for example, a radiology image, a dictation voice clip, a scanned Advance Beneficiary Notice (ABN) form, or an electrocardiogram (ECG) strip.

Data objects may be generated or accessed by one or more subscribing systems. As used herein and throughout this specification, the terms “subscribing system”, “subscribing systems”, and “subscriber” may refer to any system receiving and or providing information related to the acquisition, status, or location of one or more data objects. Specific examples include a healthcare information system, a medical imaging system, a medical document system that subscribes and links to an enterprise data directory, or specific units within a healthcare enterprise such as a pathology unit, a cardiology unit, or a radiology unit. A subscribing system may further include a variety of subsystems that are capable of capturing individual data objects including a document imaging system, an administrative workflow workstation, a front desk or customized worklist workstation, and the customized worklist workstation. Or, a subscribing system could comprise a third party system such as an Electronic Medical Record (EMR), billing system, voice recognition system, scheduling system, or dictation system. Or such systems can comprise third party devices, such as imaging equipment, hemodynamics instruments, an electrophysiological study (EPS) system, implant device monitors, electrocardiogram (ECG) equipment, Holters, inventory management systems, or Computed Tomography (CT), Magnetic Resonance Imaging (MRI), Direct Radiography (DR), a radiology information system (RIS), Computed Radiography (CR), Ultrasound (US), a Picture Archival and Communications system (PACS), or other diagnostic instruments.

System Overview

FIG. 1 is high-level block diagram of a healthcare information setting or enterprise 150 including an enterprise directory 100 in accordance with an embodiment of the invention. The enterprise directory 100 is coupled to a number of subscribing systems 110 distributed across the enterprise 150. The subscribing systems 110 receive, generate, or otherwise access information about various data objects, and regularly transmit updates about the status of these data objects in the form of notifications to the enterprise directory 100. The enterprise directory 100 processes these notifications and maintains an index of data objects and status data about the objects. The index includes references to the data objects that may comprise pointers to local repositories associated with the subscribing systems 110. Or, the references may point to copies of the electronic data objects that have been provided to the directory 100 and stored in one or more data archives or stores.

The enterprise directory 100 notifies one or more subscribing systems 110 of status changes reflected in notifications provided to it. The directory 100 may broadcast messages or alerts to one or more subscribing systems 110 according to predetermined instructions or logic that dictate, for instance that status updates concerning a specified patient be provided to a specific subscribing system 110. A user of a subscribing system 110 can access one or more data objects referenced in such a message through the enterprise directory 100. The user can also provide instructions and preferences regarding messages and notifications exchanged between a subscribing system 110 and the directory 100, as well as audit or other information to be used by the directory 100.

The health enterprise 150 comprises at least one of a medical imaging system, a medical document system, and a healthcare information system. A healthcare information system can refer to a hospital information system, a clinic information system, or any other information system in a therapeutic or diagnostic organization. The enterprise 150 may comprise an inpatient, outpatient, academic, medical teaching, hospital, clinical, diagnostic, doctor's office, or other health care setting. Users within the enterprise may control and manage data objects associated with the various subscribing systems 110. A user may be a clinician, device operator, medical administrator, doctor, nurse, orderly, health care professional, diagnostician, technician, or other medical personnel. The user may access the enterprise directory 100 in association with a subscribing system 110, for example through a billing, workflow, document management, scheduling, diagnostic, or other system 110, or independently of any such system 110. Such access may be via a specialized hardware interface, a personal computer running any of a variety of medical software applications, a company intranet, or a general web browser. In an embodiment, a user accesses data objects through a web browser on a laptop wirelessly connected to a network. This way, the user can access the image from a remote location without having to physically retrieve the file or use a special application.

The enterprise directory 100 is comprised of an interface layer 120 and a directory engine 130. Various subscribing systems 10 and users associated with the systems 110 access and interact with the enterprise directory 100 through the interface layer 120. For example, an imaging device of a subscribing system 110 may acquire a data object. A notification or message concerning the image object is transmitted by the subscribing system 110 to the enterprise directory 100 where it is received through the interface layer 120. Subsequently, the interface layer 120 broadcasts a message to relevant subscribing systems 110 containing information concerning the new data object. A notification/message to or from the enterprise directory 100 may take the form of a Health Level 7 (HL7) message or a custom XML message generated in accordance with a Microsoft Message Queuing (MSMQ) or web services protocol. It may contain address information about one or more data objects, a link or reference to the data object, or a copy of the data object. As described in more detail below, a user of a subscribing system 110 may provide instructions/preferences for receiving such messages, as well as access various data objects, change information about the objects, request reports from the directory 100, or perform other functions through the interface layer 120.

The directory engine 130 performs functions associated with providing these services to the subscribing systems 110 including processing notifications, indexing data objects, generating messages to be broadcast, and implementing auditing controls. When a notification is received from a subscribing system 110, for instance, logic in the directory engine 130 is used to process the notification and identify the data object or data object link provided therein. Information can be gleaned from the notification by virtue of the source, time, or format of the notification, data manually coded by the sender of the notification or automatically provided, or another aspect of the notification. This information can be accessed using a parser, according to a document type definition (DTD) or other file that defines the elements and data structure contained in the object, or according to another conventional or emerging method. The directory engine 130 can use the information to classify the data object referred to in the notification. In an embodiment, the directory engine 130 receives notifications formatted according to one or more existing or emerging medical or general information standards, such associated with Digital Imaging and Communications in Medicine (DICOM) or the National Electrical Manufacturers Association (NEMA). The engine 130 can consult a standards repository for resolving information contained in the notification. A DICOM image, for instance, may indicate a particular procedure for a patient. Based on information provided with the image, the directory engine 130 can generate a worklist for the patient. This worklist can further be incorporated into a message broadcast to one or more subscribing systems 110.

The notifications, messages, and data objects transmitted between the subscriber systems 110 and enterprise directory 100 may be carried via communication networks and directed to various layers and domains of the healthcare enterprise 150. Web service protocols (e.g., J2EE or Net), typically formatted in Web Services Design Language (“WSDL”) may support communications between the components to enable the interoperability of heterogeneous components. Each of the communications described may be implemented, in part, over a secured connection on a wireline or wireless local and/or wide area network or enterprise private or public network such as the Internet and/or may use any conventional networking technology, such as Ethernet, TCP/IP, or HTTP.

The system 150 of FIG. 1 include an enterprise directory 100, various subscribing systems 110, and a data object archive 160. However, it is not necessary for every embodiment of the invention to include all of the elements depicted, and others may be included. The enterprise 100, for instance, may include various standalone user access points from which the enterprise directory 100 can be accessed. Furthermore, it is not necessary for the elements to be housed as shown; elements of the interface layer 120 and directory engine 130 of the enterprise directory 100 can be hosted by separate and different standalone systems. In some implementations of the system, the various elements may also appear in different configurations. For instance, the data object archive 160 is shown in the enterprise 150 as a module separate from the enterprise directory 100, in other embodiments, however, the listener directory 100 may be integrated into the enterprise 150 or another component of the system 150. Likewise, as other elements and sub-elements are described throughout the invention, it should be understood that various embodiments of the invention may exclude elements and sub-elements described, that the elements and sub-elements may be hosted in configurations other than those shown, and that elements and sub-elements, even within an element, may be hosted in different locations or by different entities than those shown.

FIG. 2 is a block diagram of the enterprise directory 100 of FIG. 1 in accordance with an embodiment of the invention. As shown, the enterprise directory 100 includes a notifications interface 126, index repository 138, directory services engine 136, and a wide variety of modules 122-128, 132-136 to facilitate user access to data objects and information about the objects. Components in interface layer 122-128 and directory engine 132-136 are coupled communicatively to each other. For instance, instructions from a user may be passed to a component in the directory engine 130 which performs the appropriate operation and then returns the result to a module in the interface layer 120 for communication back to a user or subscribing system 110. As used herein, the term “module” can refer to computer program logic for providing specified functionality. A module can be implemented in hardware, firmware, and/or software. In addition, one of skill in the art will recognize that the concept and functionality of a module may be disclosed without specifically using the term “module.”

The enterprise data directory 100 includes a notifications interface 126 through which notifications and messages can be received and sent by the enterprise directory 100. The notifications interface 126 receives a notification from a subscribing system 110, processes it as described above, and passes on the data object or data object link and associated information to the directory services engine 136 for additional processing. The interface 126 in turn distributes messages or notifications generated by the publication module 134 to subscribing systems 110. In an embodiment the notifications interface 126 receives a data object in a message or notification received, and automatically saves a copy of the data object to the data object archive 160 and includes a pointer to the archive along with the notification that it sends to the directory services engine 136.

The directory services engine 136 indexes the data objects/data object references in one or more indexes in the index repository 138. The engine 136 can index data objects/data object references according to any of a variety of values such as a patient record number or other patient identifier, a facility, a medical condition (for the purposes of an academic study, for instance), a visit, an insurance provider, a doctor, and an encounter. As described above, this information may be contained in or one or more notifications associated with the data object by information provided in the notification. The information may also be generated by the enterprise directory 100. For instance, in an embodiment there is a patient matching module 140 capable of associating a data object and its changes, updates, or any other related events to a patient. This may be accomplished by accessing an external system or subscribing system 110 for instance that contains scheduling information from which the identity of a patient undergoing a procedure could be determined.

Such an association may be invoked at the time of a doctor office or other visit, an order of examination or diagnostics test, an examination or operation procedure, or a referral, among other things. The directory services engine 136 may also be equipped to classify and annotate data objects/data object references including with other information generated by the enterprise directory 100 including resolution information provided by or through an object exception module 135 or any other information provided by a user or through other components 122-138 of the enterprise directory 160. These sources of information can also be used for categorizing the data objects accessible through the enterprise directory 100.

Once information or a request for data (as described in more detail with reference to the management module below) has been received, the publication module 134 generates a message, notification, or alert to be distributed to one or more subscribing systems. In an embodiment, addressing information for the message is determined according to instructions provided to the enterprise directory 100, including through a management module 122. The management module 122 provides a way for users of subscribing systems 110 to express their preferences regarding, for instance what events should be noticed, the format of the notifications, and message triggers. For instance, the management module 122 can be used to indicate if a subscribing system 110 should be notified of changes in status of a data object—including about its location, creation, deletion, or other changes, what form the notice should be in—for instance by email, posted to a website, sent by a fax, or other update. For example, a diagnostic test system 110 may await a notification that contains an insurance authorization received or generated by a billing system 110 before proceeding to conducting the diagnostic test. How often notices should be sent—on a regular basis, when an event occurs, etc., may also be specified through the management module 122. A user can also specify that it would like to see certain reports pertaining to the operations of an enterprise 150—for instance relaying how many of a certain type of test was conducted over a certain period of time. Or, a user may specify that all notifications confirming testing events for a certain patient be sent to a billing subscribing system 110 for the purposes generating a bill to be sent to the patient's insurance provider.

When a user wants to access a data object, an applications module 128 can be used to launch an appropriate rendering application for various data objects upon user request. As discussed above, these data objects may be provided to the user through a link to a local repository associated with a subscribing system 100, for instance the subscribing system 100 that generated the data object. The link allows the user to access the data object over a network, using the rendering application, which is provided independently of the subscribing system 110 associated with the data object. For example, through either a standalone user interface of the enterprise directory 100 or a web browser in a enterprise directory enabled web framework as described below, a user may access an image object stored in a TIFF file by clicking on the corresponding index entry and launching a TIFF image viewer in which the objects may be viewed, analyzed, annotated, and revised. DICOM images, audio files, and other files may similarly be made available with the appropriate general or specialized application such as a cardiology image viewer or radiology image viewer. In some cases, the data object may first be converted, from a proprietary format for instance, in order to facilitate ease of distribution.

The enterprise data directory 100 may include an auditing module 124 that enables centralized auditing and access control of medical images and documents as well as other relevant data objects. A user can provide access instructions regarding who or what subscribing systems 110 may or may not access particular data objects. A secure auditing structure may be provided where access logs and other audits information may be viewed and managed.

In certain embodiments, the enterprise directory 100 includes an object exception module 135 for resolving object exceptions. Object exceptions refer to those medical data objects that cannot be readily associated with a patient by the patient matching module 140. In an embodiment, the enterprise directory 100 may consult an index in the index repository 142 and associated annotations to track patient information that may be related to the objects that have raised an exception. An object exception is resolved when the corresponding object information is identified and associated to the object. In case that no patient information is identified, the objects will be annotated as an excepted object and may be separately indexed. In this connection, the notification on exception resolutions may be provided to the subscribing systems 1 10 of the enterprise data directory 100, along with notifications of data object acquisitions, changes, data types, locations, and viewer methods or applications. In an embodiment, a user may perform resolution of an object exception, by manually supplying or overriding data object information to the directory 100 or another method.

FIG. 3 depicts exemplary interfaces for using an enterprise directory in accordance with an embodiment of the invention. The interfaces may be accessible to a user through a standalone web browser or may be integrated into a subsystem 110 application such as a billing application, healthcare information, a workflow, a medical document management, or another program. As shown in FIG. 3, various data objects may be shown to the user as listed in a directory. When a user clicks on one or more entries, a rendering application is launched and the data object rendered. The data object could be made available within the interface, or a new window could be opened. The objects can be sorted by acquisition date or by any other parameter for which there is available information. In an embodiment the interface of FIG. 3 includes a directory or searching interface through which a user can search for data objects, for instance by patient name, creation date, facility, doctor, or any available parameter. It may also include various portion through which various user inputs can be provided. For instance, it may include a management portion through which a user can provide preferences regarding notifications of data objects provided to a subscribing system 100. It could also include a report request portion wherein a user could “build” a report template that it would like populated. An interface could also include a review or auditing portion for resolving an object exception or reviewing an auditing log. Through this portion, the user could associate a data object with a patient, reconcile patient data, or input audit controls or instructions.

1. An enterprise directory system for broadcasting information about and providing access to a plurality of medical data objects generated by a plurality of subscribing systems, the system comprising:
an interface layer communicatively coupled to the plurality of subscribing systems for receiving notifications from the subscribing systems regarding the status of data objects associated with the subscribing systems;
a directory services engine communicatively coupled to the interface layer configured to maintain an index of data objects based on notifications received by the interface layer; and
a publication module for generating and broadcasting messages responsive to notifications from subscribing systems.

2. The system of claim 1, wherein the interface layer is configured to receive a plurality of notifications each comprising a pointer to a data object, and the directory services engine is configured to maintain an index of pointers to data objects associated with the notifications.

3. The system of claim 1, wherein the interface layer is configured to receive a plurality of notifications each comprising a data object and a request to save the data object, and is configured to save the data object in a data archive responsive to the request, and further wherein an index maintained by the data service module includes the location in the data archive of the saved data object.

4. The system of claim 1, wherein the interface layer is configured to receive a plurality of notifications each comprising meta data about a data object and wherein the directory services engine is configured to index the data object based on the meta data.

5. The system of claim 1, wherein the directory services engine includes a patient matching engine for associating a data object with a patient and indexing the data object according to the patient.

6. The system of claim 1, wherein the publication module is configured to generate and broadcast a message to a subscribing system responsive to instructions provided through a management module of the enterprise directory system by a user of the subscribing system.

7. The system of claim 1, further comprising an applications module configured to provide access to data objects included in the index maintained by the directory engine.

8. The system of claim 7, wherein the applications module is configured to launch an application and render a data object with the application responsive to a request to access to the data object.

9. The system of claim 8, wherein the data object is stored in a repository associated with a subscribing system and accessed over a network.

10. The system of claim 1, further comprising an object exception module for indexing a data object that has not been previously associated with a patient.

11. The system of claim 1, further comprising a data object archive for storing copies of data objects, each about which a notification has been received by the interface layer.

12. The system of claim 1, wherein the plurality of medical data objects comprises a plurality of heterogeneous data objects.

13. The system of claim 1, wherein the plurality of subscribing systems comprises a radiology system, a cardiology system, and a pathology system.

14. A method of facilitating access to a plurality of data objects produced by a plurality of subscribing systems to a user, the method comprising:
receiving a notification from a first subscribing system, the notification comprising a pointer to a data object and meta data about the data object;
storing a copy of the pointer to the data object in an index;
extracting meta data from the notification and indexing the pointer responsive to the meta data; and
creating and broadcasting a message responsive to the notification for the data object to a second subscribing system.

15. The method of claim 14, further comprising the steps of:
receiving a request from a user of the second subscribing system to access the data object; and
providing the user with access to the data object.

16. The method of claim 14, wherein the notification is triggered by at least one of: the creation of the data object, a change in the location of the data object, and an update to the data object.

17. The method of claim 14, wherein the step of indexing comprises indexing the data object by at least one of: a patient identifier, a facility, a medical condition, a visit, and an encounter.

18. The method of claim 14, wherein the step of providing the user with access to the data object further comprises retrieving the data object from the first subsystem and providing it to the user.

19. The method of claim 14, wherein the step of providing the user with access to the data object further comprises providing the user with a copy of a pointer to the data object and an instance of an application with which the data object can be rendered.

20. The method of claim 14, wherein the pointer is directed to a location selected from: a local repository associated with the first subscribing system and a data archive for storing data objects generated by a plurality of subscribing systems.

21. The method of claim 14, further comprising the steps of:
receiving an auditing instruction from the user that specifies who has access to the data object; and
responsive to the instruction, allowing or denying access to the data object to a requesting party.

22. An interface for providing a user with access to a plurality of heterogeneous medical data objects including a medical image and a billing object, the interface comprising:
a directory portion through which a user can search for data objects;
a link associated with a data object which, when selected, launches an application to render a data object; and
a management portion through which instructions regarding notifications of data objects provided to the user can be provided.

23. The interface of claim 22, wherein the interface is integrated into one of: a medical billing application, a healthcare information system, a healthcare workflow application, and a medical document management system.

24. The interface of claim 22, wherein the interface can be accessed through one of: a web framework, a subscribing system, and an enterprise directory system.

25. The interface of claim 22, wherein though the management portion is configured to accept a user input for performing one of: resolving an object exception, associating a data object with a patient, reconciling patient data, uploading a data object, and change a notification preference.
